(19) United States
(12) Patent Application Publication
(10) Pub. No.: US 2025/0203406 A1
(43) Pub. Date: Jun. 19, 2025

(54) COMMUNICATION CONTROL METHOD BASED ON USER INTENT PREDICTION AND COMMUNICATION APPARATUS

(71) Applicant: HUAWEI TECHNOLOGIES CO., LTD., Shenzhen (CN)

(72) Inventors: Jianxing Zhu, Hangzhou (CN); Rongpeng Li, Hangzhou (CN); Fei Wang, Shanghai (CN); Chenghui Peng, Shanghai (CN)

(73) Assignee: HUAWEI TECHNOLOGIES CO., LTD., Shenzhen (CN)

(21) Appl. No.: 19/069,126

(22) Filed: Mar. 3, 2025

Related U.S. Application Data
(63) Continuation of application No. PCT/CN2022/122147, filed on Sep. 28, 2022.

(51) Int. Cl. H04W 24/02; G06F 40/30

(52) U.S. Cl. CPC H04W 24/02; G06F 40/30

(57) ABSTRACT

Semantic analysis is performed on semantic data of content and/or a service that are/is historically requested by a user, to obtain intent data corresponding to the content/service historically requested by the user. After the intent data and the content and/or the service that are/is historically requested by the user (namely, historical data of the content and/or the service that are/is requested by the user) are fused, fused data is analyzed by using a deep learning algorithm, to obtain intent prediction information of the user. Advance deployment of a network architecture and advance configuration of a network resource are performed based on the intent prediction information of the user, so that the network resource is allocated correctly, properly, and in time, and proper and effective deployment of the network architecture is ensured, thereby improving communication efficiency.

### CROSS-REFERENCE TO RELATED APPLICATIONS

This is a continuation of International Application No. PCT/CN2022/122147, filed on Sep. 28, 2022, the disclosure of which is hereby incorporated by reference in its entirety.

### TECHNICAL FIELD

This disclosure relates to the communication field, and more specifically, to a communication control method based on user intent prediction and a communication apparatus.

### BACKGROUND

Over the past several decades, a wireless communication system has undergone evolution and research from a first-generation analog communication system to a 5G (new radio, NR) communication system and a future 6G communication system. The 5G communication system gradually makes emerging services such as autonomous driving, uncrewed aerial vehicles, and immersive extended reality a reality by combining development of technologies such as artificial intelligence and big data. To better serve users and save computing and bandwidth resources, flexible, on-demand, and high-quality resource allocation is often required for these services. In general, a future wireless communication network needs to strengthen fusion with artificial intelligence (AI) to build a user-centric 6G network with endogenous intelligence by using powerful prediction and decision-making capabilities of AI.

To implement more intelligent network deployment and network resource configuration, many new network architectures are proposed in the industry. A user intent-based networking (IBN) architecture attracts much attention. With introduction of a user intent, user intent analysis, policy management, and resource optimization gradually make network autonomy possible.

In recent years, user intent analysis in a natural language processing (NLP) manner gradually becomes a main research direction. An NLP model can be used to recognize (identify) the user intent to some extent. However, in a current highly dynamic time-varying network environment, advance deployment of the network architecture and advance configuration of a network resource cannot be completed. As a result, communication efficiency is affected.

### SUMMARY

This disclosure provides a communication control method based on user intent prediction and a communication apparatus, to complete advance deployment of a network architecture and advance configuration of a network resource based on intent prediction information of a user, so that the network resource is allocated correctly, properly, and in time, and proper and effective deployment of the network architecture is ensured, thereby improving communication efficiency.

According to a first aspect, a communication control method based on user intent prediction is provided. The method may be performed by a core network device, or may be performed by a chip used in a core network device. The method includes: determining user intent data based on semantic data corresponding to content and/or a service that are/is historically requested by a user, where the user intent data reflects a historical intent of the user; fusing the user intent data and historical data of the content and/or the service that are/is requested by the user; processing fused data by using a deep learning network model, to obtain intent prediction information of the user, where the intent prediction information includes a probability that the user sends a request for content and/or a service at future time; and completing advance deployment of a network architecture and advance configuration of a network resource based on the intent prediction information.

According to the communication control method based on user intent prediction provided in the first aspect, semantic analysis is performed on the semantic data of the content and/or the service that are/is historically requested by the user, to obtain the intent data corresponding to the content/service historically requested by the user. After the intent data and the content and/or the service that are/is historically requested by the user (namely, the historical data of the content and/or the service that are/is requested by the user) are fused, fused data is analyzed by using a deep learning algorithm, to obtain the intent prediction information of the user. The advance deployment of the network architecture and the advance configuration of the network resource are completed based on the intent prediction information of the user, so that the network resource is allocated correctly, properly, and in time, and proper and effective deployment of the network architecture is ensured, thereby improving communication efficiency.

For example, the historical data of the content and/or the service that are/is requested by the user includes:
a user ID of the user that initiates a request in a preset time length, an identifier ID of the content and/or the service that are/is requested in the preset time length, and time information of the request initiated by the user in the preset time length.

For example, the semantic data corresponding to the content and/or the service that are/is historically requested by the user may include keywords of the requested content and/or service, for example, a style of the requested content (for example, a movie) and a purpose of using an intelligent service. The information about the keywords may indirectly reflect a preference, a purpose, and the like of the user.

In some embodiments of the first aspect, the determining user intent data based on semantic data corresponding to content and/or a service that are/is historically requested by a user includes: separately performing, by using a natural language processing model, semantic encoding on keywords included in the semantic data, to obtain a plurality of semantic feature vectors, where the semantic feature vector indicates a semantic similarity and an analogy of the keywords; and performing semantic aggregation on the plurality of semantic feature vectors, to obtain the user intent data. In these embodiments, accuracy of the obtained user intent data can be improved.

In some embodiments of the first aspect, semantic aggregation is performed on the plurality of semantic feature vectors in at least one of the following manners, to obtain the user intent data: addition, averaging, a deep learning model based on a recurrent neural network, or a deep learning model based on an attention mechanism.

For example, for any piece of semantic data, each keyword in the semantic data may be encoded by using an NLP training model, to obtain a vector representation (namely, the semantic feature vector) including semantic features such as the semantic similarity and the analogy of the keyword, so as to implement semantic encoding. For a plurality of pieces of information about the keywords (namely, the plurality of semantic feature vectors) included in one piece of content and/or service, an aggregation operation (aggregation of the plurality of semantic feature vectors) may be performed through addition, averaging, and the deep learning model based on the recurrent neural network, the attention mechanism, or the like, to obtain the user intent data (represented in a form of a vector) of the requested content and/or service. The user intent data may reflect the intent of the user and may be used as an input of a subsequent prediction task.

In some embodiments of the first aspect, the fusing the user intent data and historical data of the content and/or the service that are/is requested by the user includes: fusing, in a manner of addition or concatenation, the user intent data and the historical data of the content and/or the service that are/is requested by the user.

In some embodiments of the first aspect, the fusing the user intent data and historical data of the content and/or the service that are/is requested by the user includes: preprocessing the historical data of the content and/or the service that are/is requested by the user; and fusing, in a manner of addition or concatenation, the user intent data and preprocessed historical data of the content and/or the service that are/is requested by the user, where the preprocessing includes at least one of averaging the historical data of the content and/or the service that are/is requested by the user, using the deep learning model based on the recurrent neural network or the attention mechanism, or selecting, based on a time parameter, the historical data of the content and/or the service that are/is requested by the user. In these embodiments, the preprocessing of the historical data of the content and/or the service that are/is requested by the user can enhance awareness of the deep learning network model on the historical data, thereby improving accuracy and precision of data processing performed by the deep learning network model.

In some embodiments of the first aspect, the processing fused data by using a deep learning network model, to obtain intent prediction information of the user includes: obtaining, by using the deep learning network model, information of nodes in the historical data of the content and/or the service that are/is requested by the user, where the nodes include the user and the content and/or the service that are/is requested by the user; generating, for each node by using the deep learning network model, a vector representation including a structure feature, a time feature, and a semantic feature, where the time feature is time at which the user requests the content and/or the service; calculating a matching value between the user and the content and/or the service by using the deep learning network model; and obtaining the intent prediction information based on the matching value. In these embodiments, accuracy of the obtained intent prediction information can be improved.

In some embodiments of the first aspect, the completing advance deployment of a network architecture and advance configuration of a network resource based on the intent prediction information includes: based on the intent prediction information and by using a monitoring network element, determining whether the intent prediction information meets a preset threshold, determining whether a current policy meets a requirement, and recording the historical data of the content and/or the service that are/is requested by the user and the semantic data corresponding to the content and/or the service that are/is historically requested by the user; updating and optimizing the current policy by using a selection network element; converting, by using a deployment network element, the current policy or an updated policy into a control instruction for a wireless network infrastructure according to a configuration instruction specification of a network parameter; and executing the control instruction by using an execution network element, to complete the advance deployment of the network architecture and advance configuration of a communication and computing resource for the content and/or the service that are/is requested by the user.

For example, corresponding operations such as reservation, addition, and deletion may be performed on a communication and computing resource (a network resource) of content and/or a service to be (future) requested by the user, to complete advance configuration of the network resource.

For example, the advance deployment of the network architecture may include advance deployment of a PCRF.

For example, the current corresponding policy may include a cache update policy, a slice resource management policy, an air interface time-frequency resource allocation policy, a core network computing resource allocation and management policy, a service function chain resource management policy, and the like.

In some embodiments of the first aspect, the monitoring network element, the selection network element, the deployment network element, and the execution network element are core network elements.

According to a second aspect, a communication apparatus is provided. The communication apparatus includes a unit configured to perform the steps according to the first aspect or any embodiments of the first aspect.

According to a third aspect, a communication apparatus is provided. The communication apparatus includes at least one processor and a memory. The at least one processor is configured to perform the method according to the first aspect or any embodiments of the first aspect.

According to a fourth aspect, a communication apparatus is provided. The communication apparatus includes at least one processor and an interface circuit. The at least one processor is configured to perform the method according to the first aspect or any embodiments of the first aspect.

According to a fifth aspect, a core network device is provided. The core network device includes any communication apparatus according to the second aspect, the third aspect, or the fourth aspect.

According to a sixth aspect, a computer program product is provided. The computer program product includes a computer program. When the computer program is executed by a processor, the method according to the first aspect or any embodiments of the first aspect is performed.

According to a seventh aspect, a computer-readable storage medium is provided. The computer-readable storage medium stores a computer program. When the computer program is executed, the method according to the first aspect or any embodiments of the first aspect is performed.

According to an eighth aspect, a chip is provided. The chip includes a processor, configured to invoke a computer program from a memory and run the computer program, so that a communication device on which the chip is installed performs the method according to the first aspect or any embodiments of the first aspect.

### BRIEF DESCRIPTION OF DRAWINGS

FIG. 1 is a diagram of an architecture of a communication system according to this disclosure;

FIG. 2 is a diagram of an example for implementing a network architecture applicable to a communication control method based on user intent prediction according to this disclosure;

FIG. 3 is a schematic flowchart of an example of a communication control method based on user intent prediction according to this disclosure;

FIG. 4A to FIG. 4C are a schematic flowchart of another example of a communication control method based on user intent prediction according to this disclosure;

FIG. 5A and FIG. 5B are a schematic flowchart of an example of an algorithm for fusing user intent data and historical data of content and/or a service that are/is requested by a user and processing fused data according to this disclosure;

FIG. 6A to FIG. 6C are a schematic flowchart of another example of a communication control method based on user intent prediction according to this disclosure;

FIG. 7A and FIG. 7B are a schematic flowchart of another example of an algorithm for fusing user intent data and historical data of content and/or a service that are/is requested by a user and processing fused data according to this disclosure;

FIG. 8 is a block diagram of a communication apparatus according to an embodiment of this disclosure;

FIG. 9 is a block diagram of a communication apparatus according to another embodiment of this disclosure; and

FIG. 10 is a block diagram of a communication apparatus according to an embodiment of this disclosure.

### DESCRIPTION OF EMBODIMENTS

The following describes technical solutions of this disclosure with reference to accompanying drawings.

In descriptions of embodiments of this disclosure, a character “/” means or unless otherwise specified. For example, A/B may indicate A or B. In this specification, a term “and/or” describes only an association relationship between associated objects and indicates that three relationships may exist. For example, A and/or B may indicate the following three cases: Only A exists, both A and B exist, and only B exists. In addition, in the descriptions in embodiments of this disclosure, “a plurality of” means two or more.

Terms such as “first” and “second” mentioned below are merely intended for description, and shall not be understood as an indication or implication of relative importance or implicit indication of a quantity of indicated technical features. Therefore, a feature limited by “first” or “second” may explicitly or implicitly include one or more features. In the description of embodiments, unless otherwise specified, “a plurality of” means two or more.

The technical solutions in embodiments of this disclosure may be applied to various communication systems, for example, a long term evolution (LTE) system, an LTE frequency division duplex (FDD) system, an LTE time division duplex (TDD) system, a 5th generation (5G) system, and a communication system evolved after 5G like a new radio (NR) communication system or a 6th generation (6G) communication system.

A terminal device mentioned in embodiments of this disclosure may be a device with a wireless transceiver function, and may be specifically user equipment (UE), an access terminal, a subscriber unit, a subscriber station, a mobile station, customer-premises equipment (CPE), a remote station, a remote terminal, a mobile device, a user terminal, a wireless communication device, a user agent, or a user apparatus. The terminal device may alternatively be a satellite phone, a cellular phone, a smartphone, a wireless data card, a wireless modem, a machine-type communication device, a cordless phone, a session initiation protocol (SIP) phone, a wireless local loop (WLL) station, a personal digital assistant (PDA), a handheld device with a wireless communication function, a computing device or another processing device connected to the wireless modem, a vehicle-mounted device, a communication device carried on a high-altitude aircraft, a wearable device, an unmanned aerial vehicle, a robot, a smart point of sale (POS) machine, a terminal in device-to-device (D2D) communication, a terminal in vehicle-to-everything (V2X), a virtual reality (VR) terminal device, an augmented reality (AR) terminal device, a wireless terminal in industrial control, a wireless terminal in self driving, a wireless terminal in telemedicine, a wireless terminal in a smart grid (smart grid), a wireless terminal in transportation safety, a wireless terminal in a smart city, a wireless terminal in a smart home, a terminal device in a future communication network, or the like.

In this embodiment of this disclosure, an apparatus configured to implement a function of the terminal device may be a terminal device, or may be an apparatus that can support the terminal device in implementing the function, for example, a chip system. The apparatus may be installed on the terminal device or used together with the terminal device. In embodiments of this disclosure, the chip system may include a chip, or may include a chip and another discrete component.

A network device mentioned in embodiments of this disclosure is a device with a wireless transceiver function, and is configured to communicate with the terminal device; or may be a device that enables the terminal device to access a wireless network. The network device may be a node in a radio access network, may also be referred to as a base station, and may be referred to as a radio access network (RAN) node (or device). The network device may be a network including a plurality of 5G-AN/5G-RAN nodes. For example, the 5G-AN/5G-RAN node may be an access point (AP), a next-generation NodeB (NR NodeB, gNB) of a base station (BS), a gNB in a form in which a central unit (CU) and a distributed unit (DU) are separated, a transmission reception point (TRP), a transmission point (TP), or another access node. The 5G-AN/5G-RAN node may alternatively be a NodeB (NB) in a wideband code division multiple access (WCDMA) system, may be an evolved NodeB (eNB, or eNodeB) in an LTE system, or may be a radio controller in a cloud radio access network (CRAN) scenario, or the access network device may be a relay station, a wireless fidelity access point (Wi-Fi AP), worldwide interoperability for microwave access (WiMAX), a network device in a 5G network, or an access network device in a future evolved public land mobile network (PLMN).

Optionally, network devices in embodiments of this disclosure may further include various forms of base stations, for example, a macro base station, a micro base station (also referred to as a small cell), a relay station, a device that implements a function of the base station in a communication system evolved after 5G, a transmission reception point (TRP), a transmission point (TP), and devices that function as base stations in a mobile switching center, device-to-device (D2D), vehicle-to-everything (V2X), and machine-to-machine (M2M) communication, and may further include a central unit (CU) and a distributed unit (DU) in a cloud radio access network (C-RAN) system, and a network device in a non-terrestrial network (NTN) communication system, that is, may be deployed on a high-altitude platform or a satellite.

In embodiments of this disclosure, the network device may communicate and interact with a core network device, to provide a communication service for the terminal device. For example, the network device may implement a radio link maintenance function, maintain a radio link between the network device and the terminal device, and be responsible for protocol conversion between radio link data and IP data quality monitoring. In addition, the network device may further implement a radio resource management function, including radio link establishment and release, radio resource scheduling and allocation, and the like. Optionally, the network device may further implement some mobility management functions, including configuring the terminal device to perform cell handover measurement, evaluating radio link quality of the terminal device, determining inter-cell handover of the terminal device, and the like.

In embodiments of this disclosure, the core network device is, for example, a device in a 5G network core network (CN). As a bearer network, the core network provides an interface to a data network, provides communication connection, authentication, management, and policy control for a terminal device, bears a data service, and the like.

A specific structure of an execution body of a method provided in embodiments of this disclosure is not particularly limited in embodiments of this disclosure, provided that communication can be performed according to the method provided in embodiments of this disclosure by running a program that records code of the method provided in embodiments of this disclosure. For example, the method provided in embodiments of this disclosure may be performed by a core network device, or a functional module that is in the core network device and that can invoke and execute the program.

In addition, aspects or features of this disclosure may be implemented as a method, an apparatus, or a product that uses standard programming and/or engineering technologies. A term “product” used in this disclosure covers a computer program that can be accessed from any computer-readable component, carrier, or medium. For example, the computer-readable medium may include but is not limited to: a magnetic storage component (for example, a hard disk, a floppy disk, or a magnetic tape), an optical disc (for example, a compact disc (CD) or a digital versatile disc (DVD)), a smart card, and a flash storage component (for example, an erasable programmable read-only memory (EPROM), a card, a stick, or a key controller). In addition, various storage media described in this specification may indicate one or more devices and/or other machine-readable media that are configured to store information. A term “machine-readable media” may include but is not limited to a radio channel, and various other media that can store, include, and/or carry instructions and/or data.

In decades, a wireless communication system has undergone evolution and research from a first-generation analog communication system to a 5G NR communication system and a future 6G communication system. In this complex evolution process, a high throughput and massive connectivity have always been core challenges for a wireless communication network. To cope with the foregoing challenges, the 5G communication system proposes disclosures such as ultra-reliable low-latency communication (URLLC), enhanced mobile broadband (eMBB), and massive machine-type communication (mMTC) as technical objectives.

In addition, the 5G communication system gradually makes emerging services such as autonomous driving, uncrewed aerial vehicles, and immersive extended reality a reality by combining development of technologies such as artificial intelligence and big data. To better serve users and save computing and bandwidth resources, flexible, on-demand, and high-quality resource allocation is often required for these services. As a result, an amount of data that needs to be processed in the network increases sharply. However, a conventional data processing and analysis manner based on statistical analysis is inefficient, and an efficient data mining technology is urgently needed. In addition, requirements of users for various performance indicators such as network reliability, a latency, and a rate are increasing. Operators also need a more intelligent and automatic operation and maintenance mode to optimize networking management. In general, a future wireless communication network needs to strengthen fusion with AI to build a user-centric 6G network with endogenous intelligence by using powerful prediction and decision-making capabilities of AI.

Currently, research on endogenous intelligence mainly focuses on the following aspects: service-oriented awareness analysis, network-oriented analysis and optimization, and traffic-oriented prediction and optimization. A network slicing service is used as an example. In conventional network slicing, a fixed physical network is divided into several logical networks, and each logical network corresponds to different services or several similar services, so that the logical network can flexibly process different application scenarios. The research on endogenous intelligence further performs awareness analysis on service traffic, a service that may be requested by a user is predicted, and a manner like deep reinforcement learning is used to optimize network resource allocation. Although a result is good, network automation and intelligence still need to be strengthened in optimizing matching between service awareness and a corresponding policy.

To implement more intelligent network deployment and network resource configuration, many new network architectures are proposed in the industry. A user intent-based networking (IBN) architecture attracts much attention. In this network architecture, network operation and maintenance do not rely on specific execution instructions. Instead, network deployment and network resource configuration are completed by analyzing a user intent, namely “a specific purpose that the user expects to achieve over the network”, and translating and then executing the user intent. Then, the network needs to monitor an overall network status to ensure that the “user intent” is correctly implemented, so as to complete closed-loop management of the network. With introduction of the user intent, user intent analysis, policy management, and resource optimization gradually make network autonomy possible.

Early research on analysis and translation of the user intent are based on some specific intent representation languages. These intent representation languages can accurately describe the user intent, but are generally not intelligent enough. Therefore, in recent years, user intent analysis in a natural language processing (NLP) manner gradually becomes a main research direction. For example, an NLP model is used to extract keywords from an input user intent text, a network knowledge base is used to match the keywords, and then reinforcement learning is used to complete optimization of a network resource allocation policy and network deployment.

The NLP model can be used to recognize (identify) the user intent to some extent. However, in a current highly dynamic time-varying network environment, this manner lacks in-depth analysis of existing data (namely, content and/or a service that are/is historically requested by the user), ignores prediction of the user intent, and cannot complete advance deployment of the network and advance configuration of the network resource. As a result, communication efficiency is affected.

In view of this, this disclosure provides a communication control method based on user intent prediction. Semantic analysis is performed on semantic data of content and/or a service that are/is historically requested by a user, to obtain intent data corresponding to the content/service historically requested by the user. After the intent data and the content and/or the service that are/is historically requested by the user (namely, historical data of the content and/or the service that are/is requested by the user) are fused, fused data is analyzed by using a deep learning algorithm, to obtain intent prediction information of the user. Advance deployment of a network architecture and advance configuration of a network resource are completed based on the intent prediction information of the user, so that the network resource is allocated correctly, properly, and in time, and proper and effective deployment of the network architecture is ensured, thereby improving communication efficiency.

First, a communication system applicable to embodiments of this disclosure is first described.

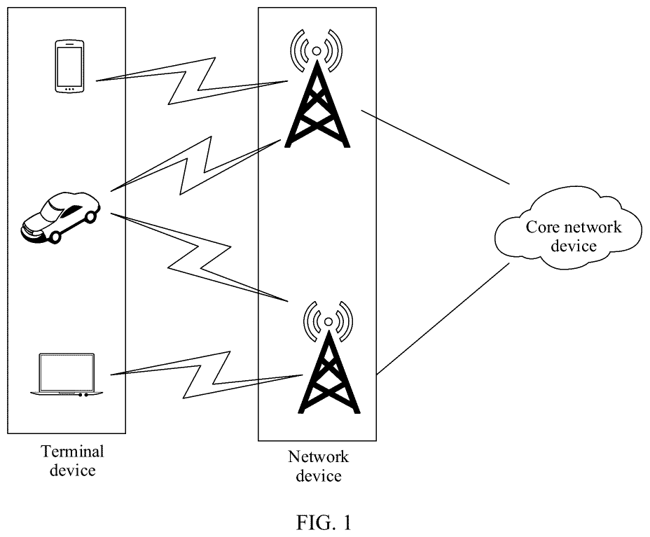

FIG. 1 is a diagram of an example of a communication system applicable to an embodiment of this disclosure. As shown in FIG. 1, the communication system includes terminal devices, network devices, and a core network device. The terminal device and the network device may be any one of the foregoing terminal device and network device.

For example, in some embodiments, in the example shown in FIG. 1, the core network device may include a management device and a gateway device.

In some embodiments, the management device may include a unified data management (UDM) network element, an access and mobility management function (AMF), a session management function (SMF), a policy control function (PCF), an application function (AF), and the like.

In some embodiments, the gateway device may include a user plane function (UPF). In some embodiments, the gateway device may further include functional units such as a branching point (BP) and an uplink classifier (UL CL). These functional units may work independently or may be combined to implement some control functions. For example, the AMF is mainly responsible for mobility management in a mobile network such as user location update, registration of a user with a network, and user switching. The SMF is mainly responsible for session management in the mobile network, for example, session establishment, modification, and release. A specific function is, for example, allocating an IP address to a user, or selecting a UPF that provides a packet forwarding function. The PCF is responsible for providing policies such as a quality of service (QoS) policy and a slice selection policy for the AMF or the SMF. The UDM is configured to store user data such as subscription information and authentication/authorization information. The AF is responsible for providing a service for a 3GPP network, for example, affecting service routing or interacting with the PCF to perform policy control. The UPF is mainly responsible for processing a user packet, for example, forwarding and charging the user packet.

For another example, the AMF, the SMF, and the PCF may be combined together as a management device, to complete access control and mobility management functions such as access authentication, security encryption, and location registration of the terminal device, session management functions such as establishment, release, and change of a user plane transmission path, and functions of analyzing some slice-related data (for example, congestion) and terminal device-related data. As the gateway device, the UPF mainly completes a function like routing and forwarding of user plane data, for example, is responsible for data packet filtering, data transmission/forwarding, rate control, charging information generation, and the like for the terminal device.

In the communication system shown in FIG. 1, the core network device may complete, by using the communication control method based on user intent prediction provided in embodiments of this disclosure, advance deployment of a network architecture (for example, the network device and each network element included in the core network device) and advance configuration of network resources (for example, a communication resource and a computing resource of the network device). For example, operations such as reservation, addition, and deletion may be implemented on content, a service, a communication and computing resource, and the like in the network.

It should be understood that the communication system shown in FIG. 1 may further include more network nodes, for example, terminal devices or network devices. The network devices or the terminal devices included in the communication system shown in FIG. 1 may be the network devices or the terminal devices in the foregoing various forms. Details are not shown one by one in the figure in this embodiment of this disclosure.

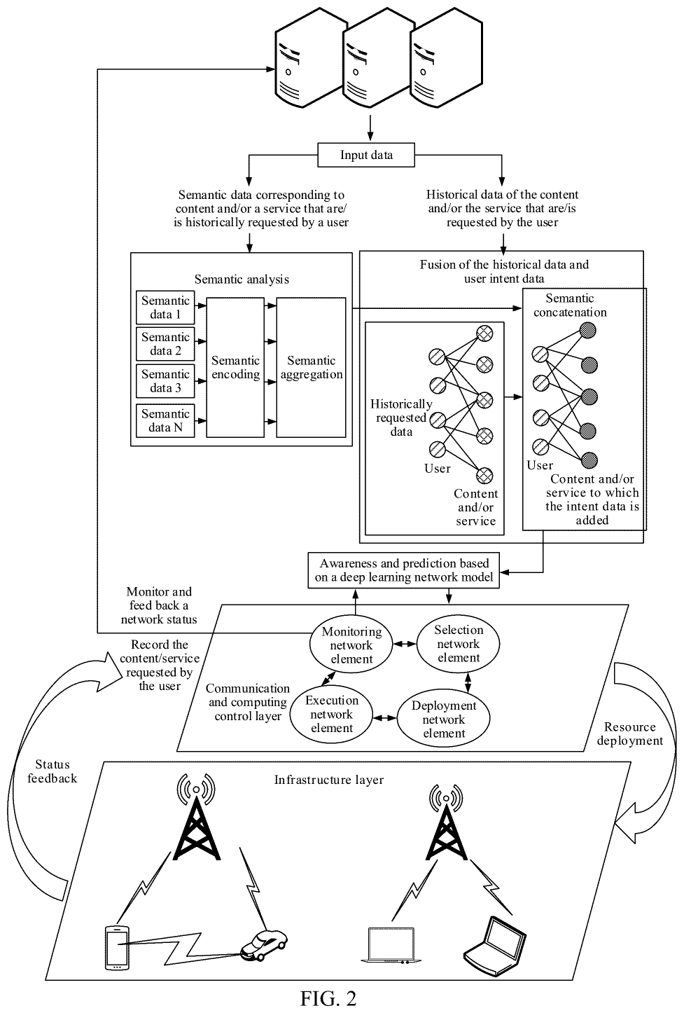

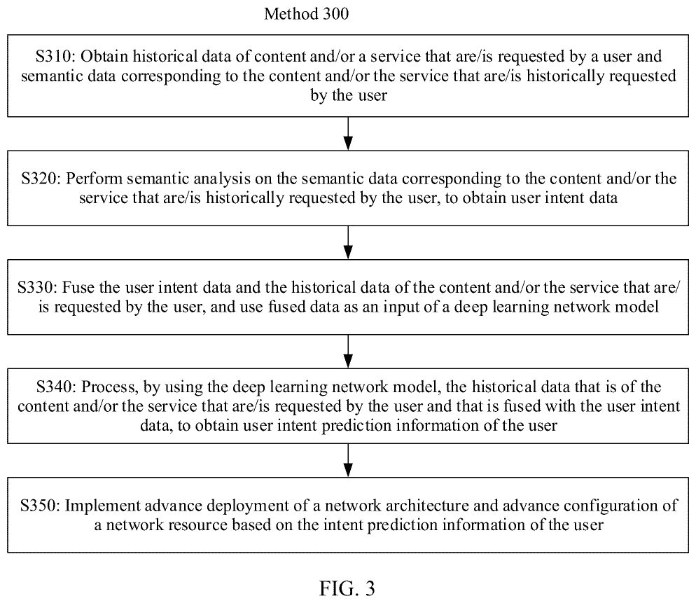

The following describes in detail the communication control method based on user intent prediction provided in this disclosure with reference to FIG. 2 and FIG. 3. FIG. 2 is a diagram of an example for implementing a network architecture applicable to the communication control method based on user intent prediction according to this disclosure. FIG. 3 is a schematic flowchart of an example of a communication control method 300 based on user intent prediction according to an embodiment of this disclosure in the network architecture shown in FIG. 2.

It should be understood that, in this embodiment of this disclosure, the communication control method based on user intent prediction may be performed by a core network device. As an example instead of a limitation, the method may be performed by a chip, a chip system, a processor, or the like used in the core network device. For example, the core network device may be a PCF, an AMF, an SMF, or the like.

As shown in FIG. 3, the method 300 shown in FIG. 3 may include S310 to S350. The following describes in detail the steps in the method 300 with reference to FIG. 3.

S310: Obtain historical data of content and/or a service that are/is requested by a user and semantic data corresponding to the content and/or the service that are/is historically requested by the user.

In some embodiments, as shown in FIG. 2, in this embodiment of this disclosure, the historical data of the content and/or the service that are/is requested by the user (or may also be referred to as a record of the content and/or the service that are/is historically requested by the user) and the semantic data corresponding to the content and/or the service that are/is historically requested by the user may be used as input data, and the core network device may analyze and process the input data, to obtain intent prediction information of the user.

It should be understood that, in this embodiment of this disclosure, the historical data of the content and/or the service that are/is requested by the user may include historical data of content and/or services requested by one or more users, and the semantic data corresponding to the content and/or the service that are/is historically requested by the user may also include semantic data corresponding to the content and/or the services historically requested by the one or more users.

In some embodiments, as shown in FIG. 2, the core network device may obtain, from a server, the historical data of the content and/or the service that are/is requested by the user and the semantic data corresponding to the content and/or the service that are/is historically requested by the user.

In this embodiment of this disclosure, the data (the record) of the content and/or the service that are/is historically requested by the user (which may also be referred to as a terminal device) may be understood as the historical data of the content and/or the service that are/is requested by the user. For example, data of content and/or a service that are/is requested by the user in a previous preset time length (for example, a previous week or a previous month) may be recorded as historical data of the content and/or the service that are/is requested by the user. For example, the historical data of the content and/or the service that are/is requested by the user may include: a user ID of the user that initiates a request in a preset time length, an identifier ID of the requested object in the preset time length, timestamp information of initiating the request in the preset time length, and the like.

In this embodiment of this disclosure, “the content and/or the service” that are/is historically requested by the user may also be referred to as an “object” historically requested by the user, and the semantic data corresponding to the content and/or the service that are/is historically requested by the user may also be referred to as semantic data corresponding to the object historically requested by the user. For example, one piece of content or service requested by the user may correspond to one piece of semantic data, and the content and/or the service that are/is historically requested by the user may include a plurality of pieces of content and/or services.

For example, the semantic data corresponding to the content and/or the service that are/is historically requested by the user may include keywords of the requested content and/or service, for example, a style of the requested content (for example, a movie) and a purpose of using an intelligent service. The information about the keywords may indirectly reflect a preference, a purpose, and the like of the user. One piece of semantic data may include a plurality of keywords.

In some embodiments, the core network device may actively query or return a user request to a content and/or service provider, and the content and/or service provider provides the semantic data corresponding to the content and/or the service that are/is historically requested by the user.

In some embodiments, the core network device may analyze and process the content and/or the service in the historical data of the content and/or the service that are/is requested by the user, for example, by using an NLP model, to obtain the semantic data corresponding to the content and/or the service that are/is historically requested by the user.

S320: Perform semantic analysis on the semantic data corresponding to the content and/or the service that are/is historically requested by the user, to obtain user intent data.

In some embodiments, in a process of performing semantic analysis on the semantic data, as shown in FIG. 2, semantic encoding may be separately performed on a plurality of pieces of semantic data of the user, to obtain semantic feature vectors. After the semantic encoding is performed, semantic aggregation is performed on the plurality of obtained semantic feature vectors, to obtain the user intent data.

For example, for any piece of semantic data, each keyword in the semantic data may be encoded by using an NLP training model, to obtain a vector representation (namely, the semantic feature vector) including semantic features such as a semantic similarity and an analogy of the keyword, so as to implement semantic encoding. For a plurality of pieces of information about the keywords (namely, the plurality of semantic feature vectors) included in one piece of content and/or service, an aggregation operation (aggregation of the plurality of semantic feature vectors) may be performed through addition, averaging, and a deep learning model based on a recurrent neural network, an attention mechanism, or the like, to obtain the user intent data (represented in a form of a vector) of the requested content and/or service. The user intent data may reflect the intent of the user and may be used as an input of a subsequent prediction task.

In this embodiment of this disclosure, the user intent data may be understood as data that can reflect the intent, the preference, or the like of the user and can explain why the user initiates the request for the content and/or the service. For example, the data includes semantic feature data such as a style and introduction information of content or effect and an expectation that can be brought by a service. These features may reflect a reason why the user initiates the request, and may be considered as the intent data.

S330: Fuse the user intent data and the historical data of the content and/or the service that are/is requested by the user, and use fused data as an input of a deep learning network model.

In some embodiments, after the user intent data is obtained, the user intent data and the historical data of the content and/or the service that are/is requested by the user may be fused in a manner of addition or concatenation, and used as the input of a subsequent prediction model (the deep learning network model), and an output of the deep learning network model is the intent prediction information of the user.

In some embodiments, after the user intent data is obtained, the historical data of the content and/or the service that are/is requested by the user may be preprocessed first, preprocessed historical data and the user intent data are fused, and the fused data is used as the input of the deep learning network model.

In this embodiment of this disclosure, the preprocessing of the historical data of the content and/or the service that are/is requested by the user (which may also be referred to as historical data for short) can enhance awareness of the deep learning network model on the historical data. For example, the preprocessing of the historical data of the content and/or the service that are/is requested by the user may include: aggregating a historical record of the content and/or the service that are/is requested by the user in a short period, so that a short-period preference expression of the user can be obtained. For the content and/or the service that are/is requested by the user in the short period, the preprocessing process may obtain feature information of a user group that prefers the service/content. The preprocessing of the historical data may be implemented in a manner of averaging records of all content and/or services requested by the user or using the deep learning model based on the recurrent neural network or the attention mechanism. Alternatively, historical data with a validity period may be selected by using an “age of the historical data” as an indicator, and the historical data obtained through selection and the user intent data are fused. The age of the historical data may be understood as information of time at which “the user requests the content and/or the service”, or may be understood as information of a time difference between time of a request of the user for the content and/or the service and time of a latest request of the user for the content and/or the service. A specific preprocessing process is not limited in this embodiment of this disclosure.

S340: Process, by using the deep learning network model, the historical data that is of the content and/or the service that are/is requested by the user and that is fused with the user intent data, to obtain the user intent prediction information.

For example, the intent prediction information of the user may include a probability that the user sends a request for content and/or a service at future time, a probability that each of a plurality of users sends a request for content and/or a service at future time, or the like.

In some embodiments, an interaction process of historical data (namely, historical data of content and/or a service that are/is requested by a user) may be abstracted as a dynamically evolved bipartite graph, and the bipartite graph includes two types of nodes: the user and an object (the content and/or the service) requested by the user. Therefore, an edge of the bipartite graph is a request initiated by the user for content and/or a service, the interaction process is dynamic to some extent, and timestamp information of interaction occurred is recorded. For this dynamic bipartite graph, a dynamic graph neural network model may be used to complete a task of analyzing and predicting a user intent. The historical data that is of the content and/or the service that are/is requested by the user and that is fused with user intent data is used as an input, and a specific vector representation that includes a structure feature, a time feature, and a semantic feature is generated for each node, then a matching value between the user and the requested content and/or service is calculated based on multilayer perception, and training of the dynamic graph neural network model is completed by using a current network status as label information. After the training is completed, the dynamic graph neural network model is used to complete a prediction result of a future intent of the user by using, as an input, historical data of the content and/or the service that are/is requested by the user for several times recently and corresponding user intent data, and the prediction result of the future intent of the user may be used as a basis for determining whether the user initiates a request for the content/service.

S350: Implement advance deployment of a network architecture and advance configuration of a network resource based on the intent prediction information of the user.

In this embodiment of this disclosure, the intent prediction information of the user may be used as a basis for determining whether the user initiates a request for content and/or a service in the future. After obtaining the intent prediction information of the user (that is, the user sends a request for content and/or a service at future time), the core network device sends an instruction with reference to the current network status, to complete the advance deployment of the network architecture (for example, deployment of a policy and charging rules function (PCRF) unit) and advance deployment, optimization, delivery, and execution of corresponding policies (for example, a cache update policy, a slice resource management policy, an air interface time-frequency resource allocation policy, a core network computing resource allocation and management policy, and a service function chain resource management policy), monitors and feeds back a network running status to an upper-layer structure in real time, and completes closed-loop management of the network, to ensure that computing resources of the content and/or the service are allocated correctly, properly, and in time after operations such as reservation, addition, and deletion, so as to meet the future intent of the user, thereby better implementing the user intent and improving user experience.

In some embodiments, as shown in FIG. 2, at a communication and computing control layer, a monitoring network element, a selection network element, a deployment network element, and an execution network element may be configured to implement the advance deployment of the network architecture (namely, advance deployment of an infrastructure layer) and the advance configuration of the network resource based on the intent prediction information of the user. For example, a communication resource for the content and/or the service that are/is requested by the user may be selected, deployed, executed, and monitored based on the intent prediction information of the user. In some embodiments, the monitoring network element, the selection network element, the deployment network element, and the execution network element may all be network elements included in a core network.

The monitoring network element is mainly configured to: monitor and feed back the network status. For example, the monitoring network element may periodically analyze accuracy of intent prediction of the user, execution effect of the current deep learning network model, and the like, to determine whether the deep learning network model needs to be retrained. If an intent prediction result of the user is lower than a preset threshold, the monitoring network element sends an instruction to a model training unit to retrain the deep learning network model.

In some embodiments, the monitoring network element may further determine, with reference to an output result (namely, the intent prediction information of the user) of the deep learning network model, whether the existing policy (for example, the cache update policy, the slice resource management policy, the air interface time-frequency resource allocation policy, the core network computing resource allocation and management policy, and the service function chain resource management policy) needs to be updated and optimized, and if the current policy cannot meet a requirement (for example, determining by comparing the current network status with a threshold standard set under the specific content and/or service included in the intent prediction information, for example, whether a cache hit rate of the content and/or the service cached in the current cache policy is higher than a threshold), send indication information to the selection network element, for the selection network element to optimize policy update based on the indication information. After the selection network element completes update, deployment, and execution of content such as the policy, the monitoring network element may further perform continuous awareness on the network status, to ensure that the updated policy is correctly executed. If finding that the network status cannot meet the predicted user intent, the monitoring network element sends indication information to the selection network element. After receiving the indication information, the selection network element updates the policy. If the policy still cannot meet the requirement after being updated for a plurality of times, the selection network element determines that the deep learning network model needs to be retrained. In addition, the monitoring network element may further continuously record the data of the requested content and/or service, the semantic data corresponding to the requested content and/or service, the network status information, and the like, and periodically send the data to the server for storage after completing a specific privacy protection operation.

The selection network element is mainly used to select an appropriate optimization algorithm, for example, a reinforcement learning algorithm and a convex optimization algorithm, to update and optimize the policy based on a policy determining result of the monitoring network element and with reference to the intent prediction information of the user.

The deployment network element is mainly configured to: convert a corresponding policy into a control instruction for a wireless network infrastructure with reference to a configuration instruction specification of a network parameter, and deliver the control instruction to a corresponding physical device (for example, a base station), to complete the advance deployment of the network architecture.

The execution network element is mainly configured to perform the corresponding operations such as reservation, addition, and deletion on a communication and computing resource (a network resource) of content and/or a service to be (future) requested by the user, to complete the advance configuration of the network resource.

According to the communication control method based on user intent prediction provided in this disclosure, the content and/or service data that are/is historically requested by the user and the semantic data of the requested object that can reflect the user intent are recorded. Encoding and aggregation of the semantic data are completed through natural language processing, to obtain the user intent data. The content and/or service data that are/is historically requested by the user is fused with the user intent data. Based on the historical data that is fused with the user intent data, the deep learning model is used to complete the prediction task of the next intent of the user. The advance deployment of the network architecture and the advance configuration of the network resource are completed based on the prediction result. This ensures that the network resource is allocated correctly, properly, and in time, and proper and effective deployment of the network architecture, thereby improving communication efficiency.

The following describes, with reference to a specific example, the communication control method based on user intent prediction provided in this disclosure.

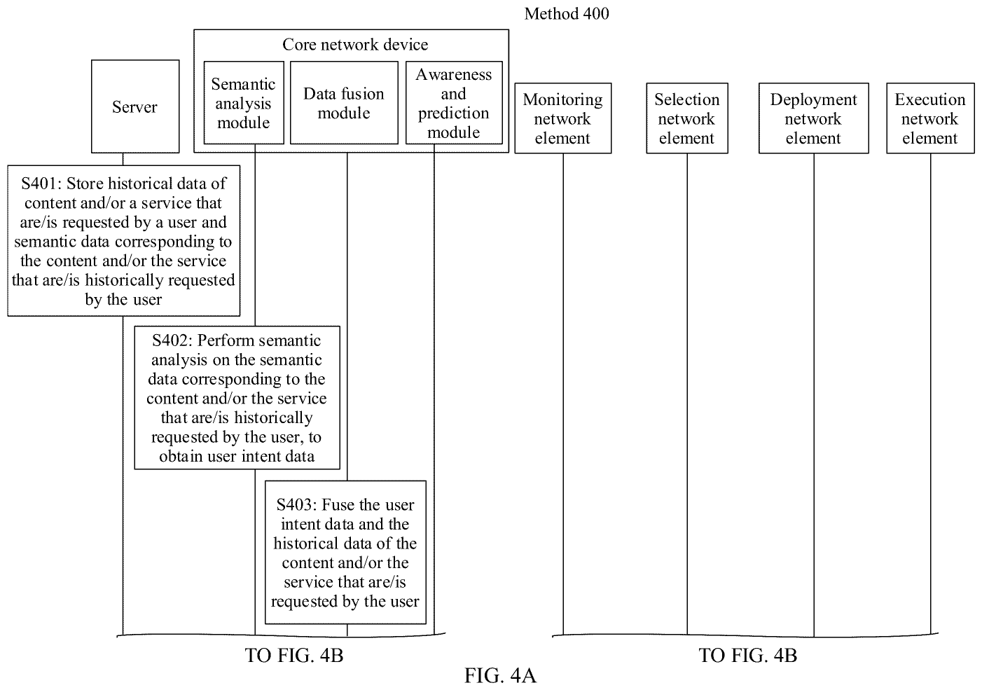

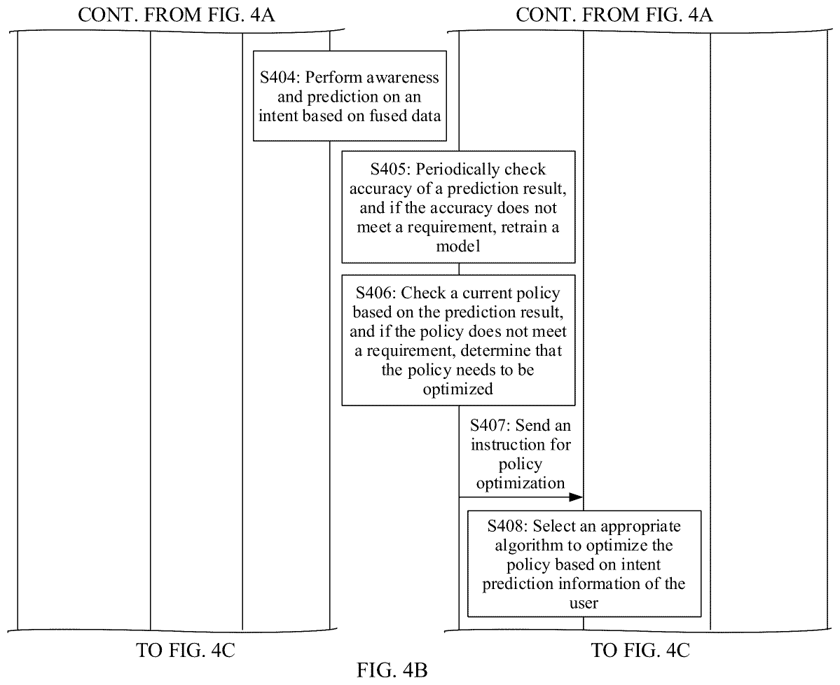

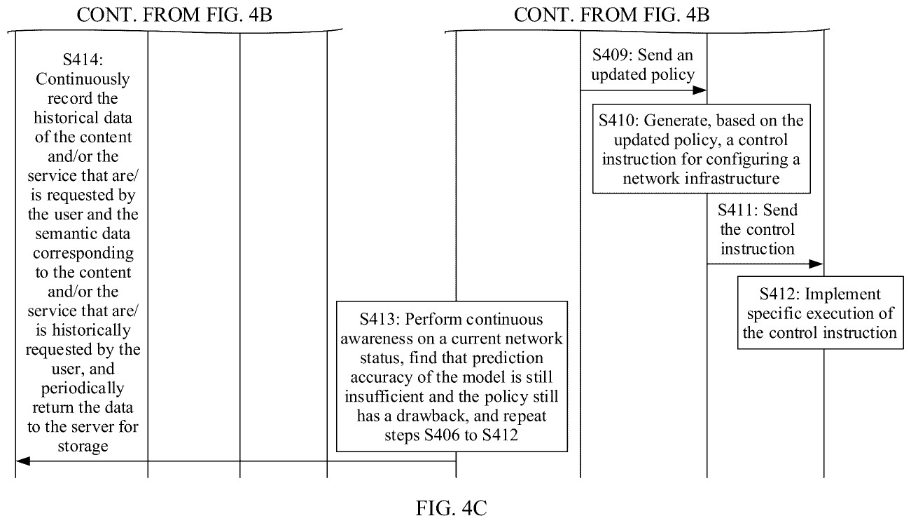

FIG. 4A to FIG. 4C are a schematic flowchart of another example of a communication control method 400 based on user intent prediction according to an embodiment of this disclosure. As shown in FIG. 4A to FIG. 4C, the method 400 includes the following steps.

S401: Record, in a server, historical data of content and/or a service that are/is requested by a user and semantic data corresponding to the content and/or the service that are/is historically requested by the user.

A monitoring network element in a core network device may record, in the server, the historical data of the content and/or the service that are/is requested by the user and the semantic data that can reflect a user intent, for a subsequent task like model training.

For example, the historical data of the content and/or the service that are/is requested by the user mainly includes: a user ID, an identifier ID of the requested content and/or service, and timestamp information of initiating a request.

The semantic data corresponding to the content and/or the service that are/is historically requested by the user may include keywords of the requested content and/or service, for example, a style of the content (music, a video, news, or the like) and a purpose of using an intelligent service (catering, entertainment, healthcare, or the like). Information about the keywords may indirectly reflect a preference, a purpose, and the like of the user, and therefore can also be used as an input for analyzing the user intent. In addition, a difference between a manner of passively receiving and processing a user input statement to obtain an intent in a general intent network and this disclosure lies in that awareness on the user intent is performed by analyzing the semantic data of the object (the content and/or the service) requested by the user, which is a proactive intent analysis manner. In addition, in this embodiment of this disclosure, a current network status may be further recorded, and is used as a label for training a deep learning network model. The monitoring network element uses the foregoing information as the input, and stores the information in a specific storage server.

S402: Perform semantic analysis on the semantic data corresponding to the content and/or the service that are/is historically requested by the user, to obtain user intent data.

In some embodiments, in a process of performing semantic analysis on the semantic data, a semantic analysis module in the core network device may encode the recorded semantic data of the requested content and/or service, to generate a vector including a semantic feature, and aggregate multilayer semantic information included in the vector, so as to obtain the user intent data. The user intent data may reflect an intent of a historical request of the user, that is, reflect a historical intent of the user.

In some embodiments, to implement an encoding operation on the semantic data, some pre-trained natural language models such as ELMo, BERT, and Glove may be used, and word embedding expressions obtained by using these pre-trained models generally have good semantic features such as a semantic similarity and an analogy between words. The semantic features can add an implicit semantic relationship between the data requested by the user, to facilitate analysis, awareness, and prediction of the user intent. In addition, because the requested object (the content and/or the service), for example, content like a movie or various types of communication services, may include a plurality of pieces of information about the keywords, to facilitate subsequent processing, a specific aggregation operation needs to be performed on the information about the keywords. The aggregation operation on the semantic data includes but is not limited to summing up and averaging all semantic data, or using a deep learning model based on a recurrent neural network and an attention mechanism and various variant models thereof. After the aggregation operation is completed, a semantic representation (namely, the user intent data) of the requested object is obtained.

S403: A data fusion module in the core network device fuses the user intent data and the historical data of the content and/or the service that are/is requested by the user, and uses fused data as an input of the deep learning network model.

In some embodiments, in a process of fusing the user intent data and the historical data of the content and/or the service that are/is requested by the user, the user intent data that reflects the user intent and the feature vector corresponding to the content and/or the service that are/is requested by the user may be fused in a manner of concatenation or addition in a direct fusion manner, and a specific vector representation that includes a semantic feature is generated for each content and/or service, and is used as an input of a subsequent prediction model.

S404: An awareness and prediction model in the core network device performs awareness and prediction on the user intent based on the fused data and by using the deep learning network model.

In S404, the awareness and prediction model in the core network device processes, by using the deep learning network model, the historical data that is of the content and/or the service that are/is requested by the user and that is fused with the user intent data, to obtain intent prediction information (namely, a prediction result) of the user.

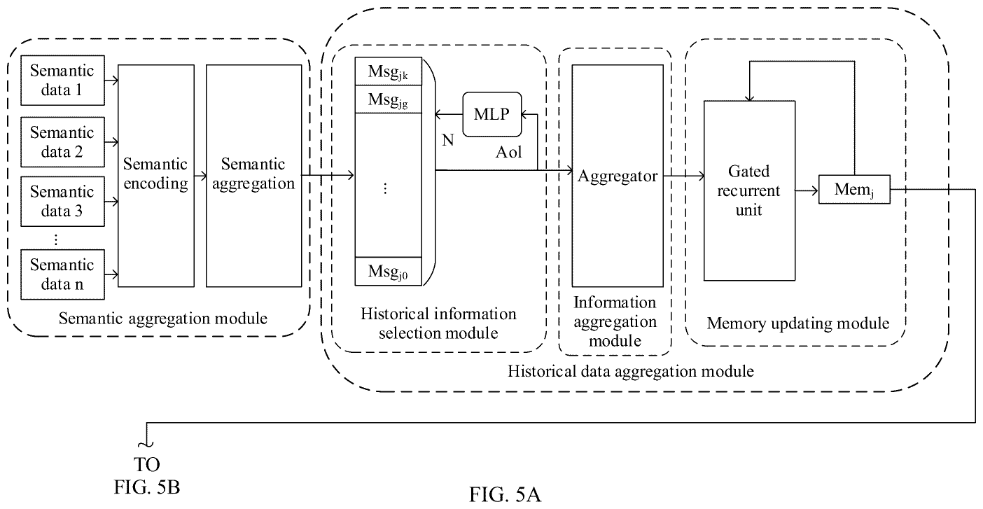

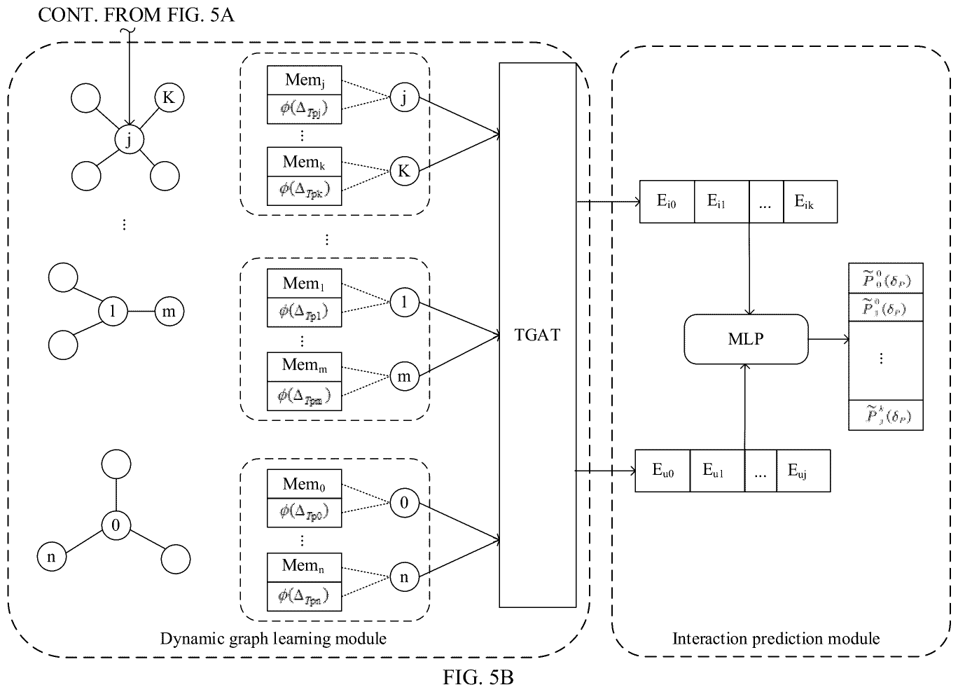

In some embodiments, specific algorithm processes of S403 and S404 are shown in FIG. 5A and FIG. 5B.

As shown in FIG. 5A and FIG. 5B, after a plurality of pieces of semantic data are obtained by completing semantic encoding on the plurality of keywords, semantic aggregation may be performed on the semantic data through summation, averaging, the deep learning model, or the like. Then, the direct fusion manner is used to add, in the manner of concatenation or addition, the data obtained through the semantic aggregation to the vector representation (namely, the historical data of the content and/or the service that are/is requested by the user) used to represent the requested object (the content and/or the service), to perform a fusion operation.

The historical data fused with the semantic data is selected based on an “information age”, and the aggregation operation is performed on the historical data by using a neural network means like the averaging mechanism or the attention mechanism, to obtain a short-period interest representation of the user. The recurrent neural network or various variants of the recurrent neural network, for example, a gated recurrent unit (GRU) or a long short-term memory (LSTM) network is used, and the short-period interest representation of the user is used as an input, to obtain a long-period general interest representation of the user through updating. A vector representation of a user group representation of the requested object is obtained by repeating the foregoing steps.

The long-period general interest representation of the user and the user group representation of the requested object are used as an input, interaction between the long-period general interest representation of the user and the user group representation of the requested object is abstracted as a dynamically evolved bipartite graph, and the timestamp information of the corresponding content and/or service is concatenated. A temporal graph attention network (TGAT) model is used to analyze a time feature and a structure feature of the interaction, to obtain vector representations of the user and the requested object that include the time feature, the structure feature, and the semantic feature. A matching value between the user and the requested content and/or service is calculated based on multilayer perception, and training of a dynamic graph neural network model is completed by using the current network status as label information.

After the training is completed, the dynamic graph neural network model is used to complete a prediction result of a future intent of the user by using, as an input, historical data of the content and/or the service that are/is requested by the user for several times recently and corresponding user intent data, and the prediction result of the future intent of the user may be used as a basis for determining whether the user initiates a request for the content/service.

After S404, the core network device performs communication and computing control based on the prediction result, and the step is mainly performed at a communication and computing control layer. Four types of network elements at the communication and computing control layer may complete deployment, optimization, delivery, and execution of a corresponding policy in advance based on information such as the network status and the prediction result, monitor and feed back a network running status in real time, and complete closed-loop management of the network, to ensure that a communication and computing resource is allocated correctly, properly, and in time, and the corresponding content and/or service can meet the future intent of the user.

As shown in the procedure shown in S405 to S413 in FIG. 4A to FIG. 4C, the monitoring network element learns, through awareness, that accuracy of the deep learning network model is low, and finds, through retraining, that the policy does not meet a requirement. After completing selection, deployment, and execution, the monitoring network element learns again, through awareness, that the policy does not meet the requirement, and the deep learning network model needs to be retrained and the policy needs to be optimized for a plurality of times.

S405: The monitoring network element periodically checks accuracy of the intent prediction information of the user, and if the accuracy of the intent prediction of the user (namely, the prediction result) is lower than a preset threshold, determines that the deep learning network model needs to be retrained. In this case, the monitoring network element may send an instruction to the awareness and prediction module to retrain the deep learning network model. If the retrained deep learning network model still does not meet the requirement, the step is repeated.

S406: The monitoring network element analyzes, based on a prediction result of the updated deep learning network model and with reference to a network status, whether a current policy (for example, a cache update policy, a slice resource management policy, an air interface time-frequency resource allocation policy, a core network computing resource allocation and management policy, and a service function chain resource management policy) can meet a requirement, whether policy optimization needs to be performed, and the like. If finding that the current policy does not meet the requirement, the monitoring network element determines that the current policy still needs to be further optimized.

S407: The monitoring network element sends, to a selection network element, an instruction indicating that policy optimization is required.

S408: The selection network element selects an appropriate algorithm, for example, a deep reinforcement learning algorithm or a convex optimization algorithm, to optimize the policy based on the intent prediction information of the user.

S409: After completing the policy optimization, the selection network element sends an updated policy to a deployment network element.

S410: The deployment network element generates, based on the updated policy and with reference to a configuration instruction specification of a network parameter, a control instruction for configuring a network infrastructure (for example, a base station). For example, the control instruction may include: converting the updated policy into a specific instruction, a conflict resolution management instruction between the formulated policy and a current network management configuration, and the like.

S411: The deployment network element sends the control instruction to an execution network element.

S412: The execution network element receives the control instruction, and implements specific execution of the control instruction. For example, operations such as reservation, addition, and deletion of the communication and computing resource of the content and/or the service are completed.

S413: The monitoring network element performs continuous awareness on the current network status, finds that prediction accuracy of the deep learning network model is still insufficient and the policy still has a drawback, and repeats steps S406 to S412.

S414: The monitoring network element continuously records the historical data of the content and/or the service that are/is requested by the user and the semantic data corresponding to the content and/or the service that are/is historically requested by the user, and periodically returns the data to the server for storage.

According to the communication control method based on user intent prediction provided in this disclosure, the content and/or service data that are/is historically requested by the user and the semantic data of the requested object that can reflect the user intent are recorded. Encoding and aggregation of the semantic data are completed through natural language processing, to obtain the user intent data. The content and/or service data that are/is historically requested by the user is fused with the user intent data. Based on the historical data that is fused with the user intent data, the deep learning model is used to complete the prediction task of the next intent of the user. Based on the prediction result, the monitoring network element, the selection network element, the deployment network element, and the execution network element send the instructions with reference to the current network status, to complete the advance deployment of the network architecture and the deployment, optimization, delivery, and execution of the corresponding policy (for example, the cache update policy or the slice resource management policy), monitor and feed back the network running status to the upper-layer structure in real time, and complete the closed-loop management of the network, to ensure that the computing resources of the content and/or the service are allocated correctly, properly, and in time after the operations such as reservation, addition, and deletion, so as to meet the future intent of the user, thereby improving communication efficiency.

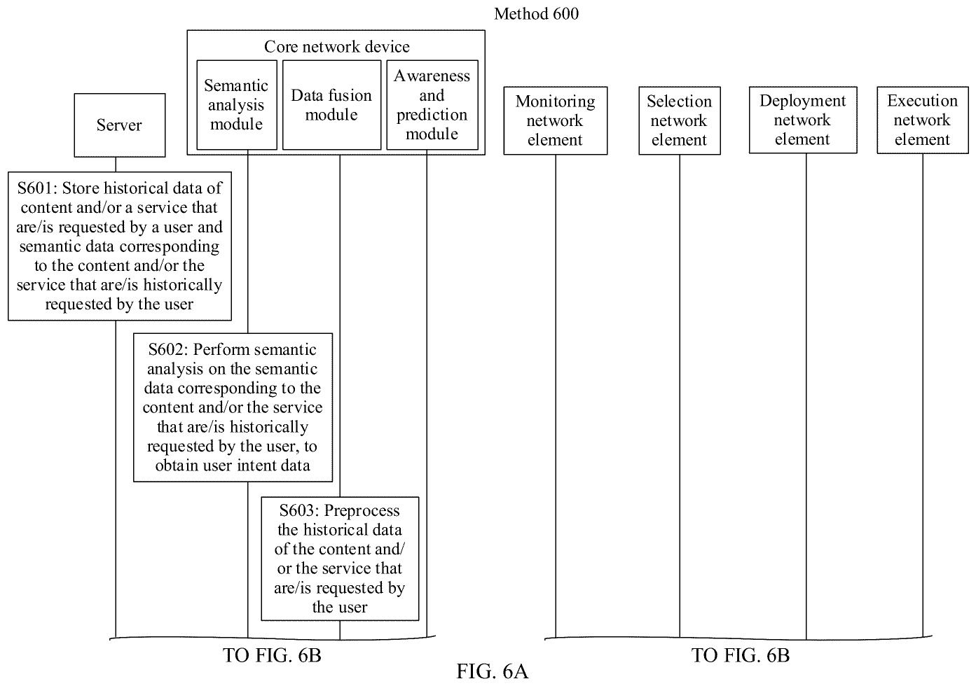

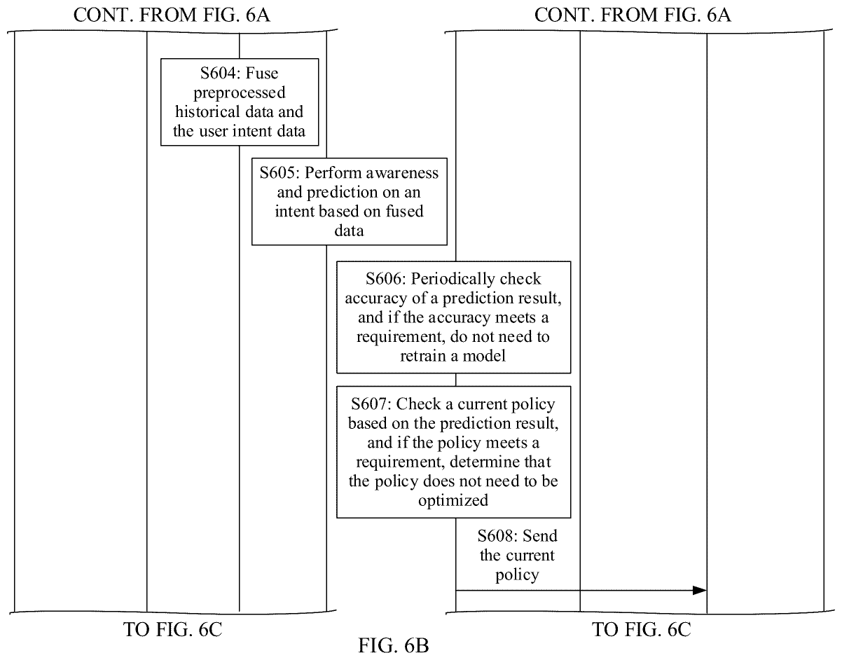

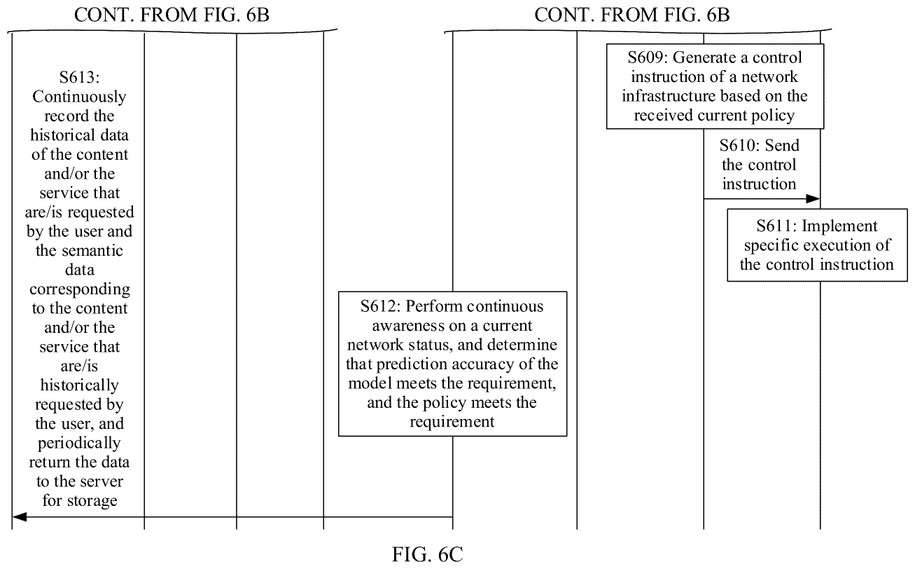

FIG. 6A to FIG. 6C are a schematic flowchart of another example of a communication control method 600 based on user intent prediction according to an embodiment of this disclosure. As shown in FIG. 6A to FIG. 6C, the method 600 includes the following steps.

S601: Record, in a server, historical data of content and/or a service that are/is requested by a user and semantic data corresponding to the content and/or the service that are/is historically requested by the user.

S602: Perform semantic analysis on the semantic data corresponding to the content and/or the service that are/is historically requested by the user, to obtain user intent data.

For specific descriptions of S601 and S602, refer to the specific descriptions corresponding to S401 and S402 in the method 400. For brevity, details are not described herein again.

S603: A data fusion module in a core network device preprocesses the historical data of the content and/or the service that are/is requested by the user.

In this embodiment of this disclosure, the preprocessing of the historical data of the content and/or the service that are/is requested by the user (which may also be referred to as historical data for short) can enhance awareness of a deep learning network model on the historical data. For example, the preprocessing of the historical data of the content and/or the service that are/is requested by the user may include: aggregating a historical record of the content and/or the service that are/is requested by the user in a short period, so that a short-period preference expression of the user can be obtained. For the content and/or the service that are/is requested by the user in the short period, the preprocessing process may obtain feature information of a user group that prefers the service/content. The preprocessing of the historical data may be implemented in a manner of averaging records of all content and/or services requested by the user or using a deep learning model based on a recurrent neural network or an attention mechanism. Alternatively, historical data with a validity period may be selected by using an “age of the historical data” as an indicator, and the historical data obtained through selection and the user intent data are fused, and the like. A specific preprocessing process is not limited in this embodiment of this disclosure.

S604: The data fusion module in the core network device fuses preprocessed historical data and the user intent data, and uses fused data as an input of the deep learning network model.

For example, the user intent data that reflects the user intent and the user group feature information in the preprocessed historical data may be fused in a manner of concatenation or addition, and a specific vector representation that includes a semantic feature is generated for each content and/or service, and is used as an input of a subsequent prediction model.

S605: An awareness and prediction model in the core network device performs awareness and prediction on the user intent based on the fused data and by using the deep learning network model.

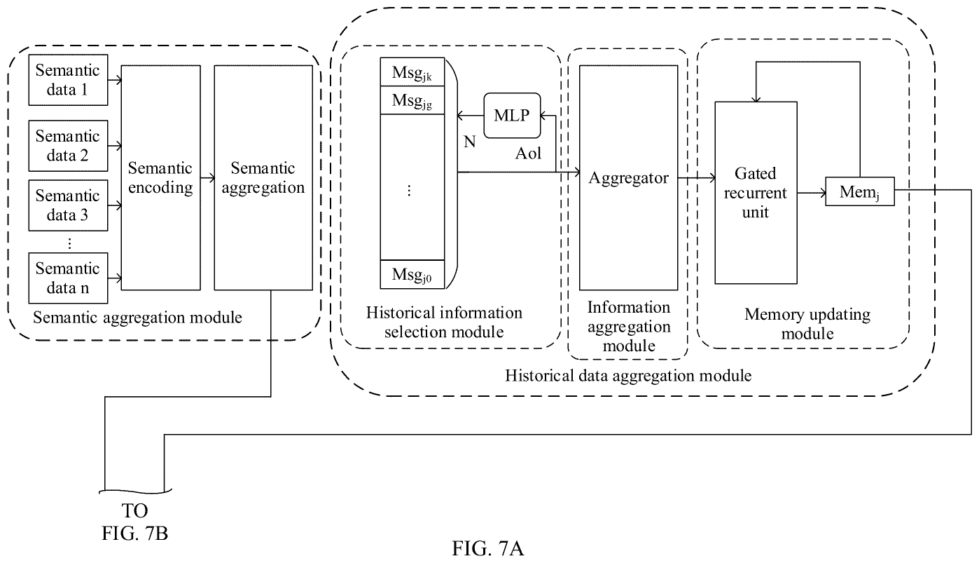

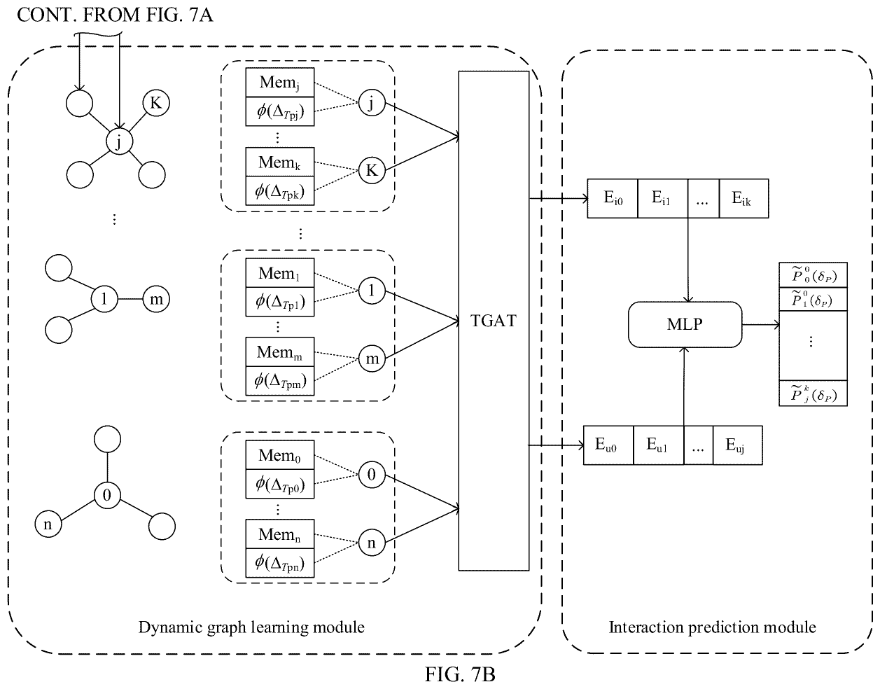

In some embodiments, specific algorithm processes of S603 to S605 are shown in FIG. 7A and FIG. 7B.

As shown in FIG. 7A and FIG. 7B, after a plurality of pieces of semantic data are obtained by completing semantic encoding on a plurality of keywords, semantic aggregation is performed on the semantic data through summation, averaging, or the deep learning model.

The historical data is selected based on an “information age”, and preprocessing of an aggregation operation on the historical data is performed by using a neural network means like averaging or the attention mechanism, to obtain a short-period interest representation of the user. The recurrent neural network or various variants of the recurrent neural network, for example, a GRU or an LSTM is used, and the short-period interest representation of the user is used as an input, to obtain a long-period general interest representation of the user through updating. A general user group representation of the requested object is obtained by repeating the foregoing steps.

Then, a direct fusion manner is used to add, in the manner of concatenation or addition, the semantic data to the user group representation used to represent the requested object, to perform a fusion operation.

The long-period general interest representation of the user and the user group representation of the requested object are used as an input, interaction between the long-period general interest representation of the user and the user group representation of the requested object is abstracted as a dynamically evolved bipartite graph, and a TGAT is used to analyze a time feature and a structure feature of the interaction, to obtain vector representations of the user and the requested object that include the time feature, the structure feature, and the semantic feature. A matching value between the user and the requested content and/or service is calculated based on multilayer perception, and training of a dynamic graph neural network model is completed by using a current network status as label information.

After the training is completed, the dynamic graph neural network model is used to complete a prediction result of a future intent of the user by using, as an input, historical data of the content and/or the service that are/is requested by the user for several times recently and corresponding user intent data, and the prediction result of the future intent of the user may be used as a basis for determining whether the user initiates a request for the content/service.

S606: A monitoring network element periodically checks accuracy of the intent prediction information of the user, and if the accuracy of the intent prediction of the user (namely, the prediction result) is greater than or equal to a preset threshold, determines that accuracy of the deep learning network model meets a requirement. In this case, the monitoring network element may determine that the deep learning network model does not need to be retrained.

S607: The monitoring network element analyzes, based on a prediction result of the deep learning network model and with reference to a network status, whether a current policy can meet a requirement, whether policy optimization needs to be performed, and the like. If finding that the current policy can meet the requirement, the monitoring network element determines that the current policy does not need to be updated.

S608: The monitoring network element sends the current policy to a deployment network element.

S609: The deployment network element generates, based on the received current policy and with reference to a configuration instruction specification of a network parameter, a control instruction for configuring a network infrastructure (for example, a base station).

S610: The deployment network element sends the control instruction to an execution network element.

S611: The execution network element receives the control instruction, and implements specific execution of the control instruction. For example, operations such as reservation, addition, and deletion of a communication and computing resource of the content and/or the service are completed.

S612: The monitoring network element performs continuous awareness on the current network status, and determines that the prediction accuracy of the deep learning network model can meet the requirement, and the policy also meets the requirement.

S613: The monitoring network element continuously records the historical data of the content and/or the service that are/is requested by the user and the semantic data corresponding to the content and/or the service that are/is historically requested by the user, and periodically returns the data to the server for storage.

According to the communication control method based on user intent prediction provided in this disclosure, the content and/or service data that are/is historically requested by the user and the semantic data of the requested object that can reflect the user intent are recorded. Encoding and aggregation of the semantic data are completed through natural language processing, to obtain the user intent data. The content and/or service data that are/is historically requested by the user is preprocessed, and the preprocessed data is fused with the user intent data. Based on the historical data that is fused with the user intent data, the deep learning model is used to complete the prediction task of the next intent of the user. Based on the prediction result, the monitoring network element, the selection network element, the deployment network element, and the execution network element complete the advance deployment of the network architecture and the advance configuration of the network resource, monitor and feed back the network running status to the upper-layer structure in real time, and complete the closed-loop management of the network, to ensure that the network resource is allocated correctly, properly, and in time, thereby improving the communication efficiency.

It should be understood that the foregoing descriptions are merely intended to help a person skilled in the art better understand embodiments of this disclosure, but are not intended to limit the scope of embodiments of this disclosure. It is clear that a person skilled in the art may make various equivalent modifications or changes based on the foregoing examples. For example, some steps in the foregoing methods may be unnecessary, or some steps may be newly added. Alternatively, any two or more of the foregoing embodiments are combined. A modified, changed, or combined solution also falls within the scope of embodiments of this disclosure.

It should be further understood that division into manners, cases, categories, and embodiments in embodiments of this disclosure is merely intended for ease of description, and should not constitute a particular limitation. The features in the manners, categories, cases, and embodiments may be combined without contradiction.

It should be further understood that various numbers in embodiments of this disclosure are merely used for distinguishing for ease of description and are not used to limit the scope of embodiments of this disclosure. Sequence numbers of the foregoing processes do not mean execution sequences. The execution sequences of the processes should be determined based on functions and internal logic of the processes, and should not constitute any limitation on implementation processes of embodiments of this disclosure.

It should be further understood that the foregoing descriptions of embodiments of this disclosure emphasize differences between embodiments. For same or similar parts that are not mentioned, refer to embodiments. For brevity, details are not described herein again.

In embodiments, the core network device (including the monitoring network element, the selection network element, the deployment network element, the execution network element, and the like) may be divided into functional modules according to the foregoing method. For example, each functional module may be obtained through division based on each corresponding function, or two or more functions may be integrated into one processing module. The integrated module may be implemented in a form of hardware. It should be noted that, in embodiments, division into the modules is an example, is merely logical function division, and may be other division in some embodiments.

It should be noted that related content of the steps in the foregoing method embodiments may be referenced to function descriptions of corresponding functional modules. Details are not described herein again.

The core network device provided in embodiments of this disclosure is configured to perform any communication control method based on user intent prediction provided in the foregoing method embodiments, and therefore can achieve effect the same as that of the foregoing method. When an integrated unit is used, the core network device (or may be referred to as a core network element) may include a processing module, a storage module, and a communication module. The processing module may be configured to control and manage an action of the network element. For example, the processing module may be configured to support the network element in performing steps performed by a processing unit. The storage module may be configured to support storage of program code, data, and the like. The communication module may be configured to support communication between the network element and another device.

The processing module may be a processor or a controller. The processing module may implement or execute various example logical blocks, modules, and circuits described with reference to the content disclosed in this disclosure. The processor may alternatively be a combination implementing a computing function, for example, a combination of one or more microprocessors, a combination of a digital signal processor (digital signal processor, DSP) and a microprocessor, or the like. The storage module may be a memory. The communication module may be specifically a device, for example, a radio frequency circuit, a Bluetooth chip, a Wi-Fi chip, or the like that interacts with another device.

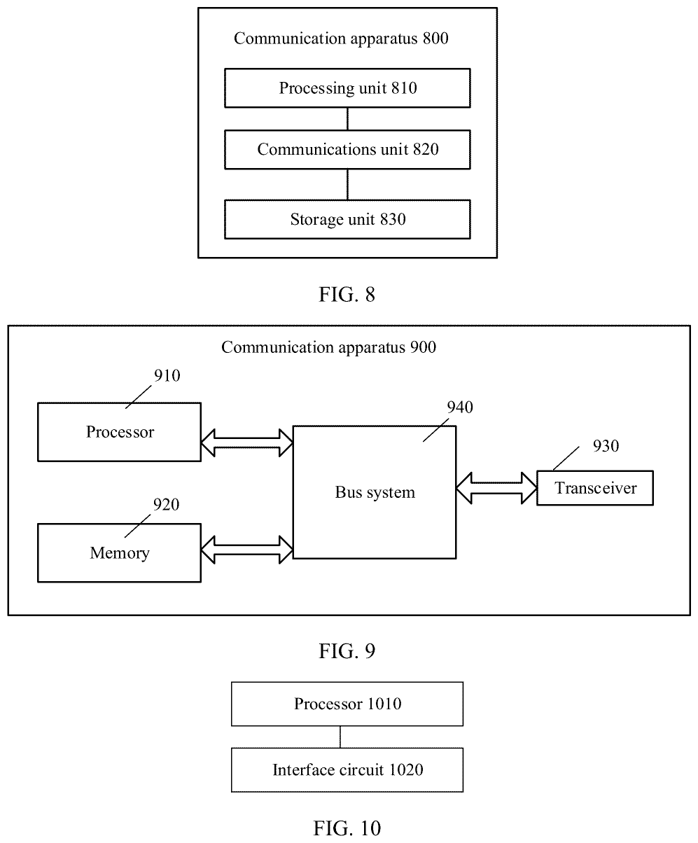

FIG. 8 is a block diagram of an example of a communication apparatus according to an embodiment of this disclosure. The communication apparatus 800 may correspond to the core network device described in the foregoing method embodiments. Alternatively, the communication apparatus 800 may be a chip or a component used in the core network device. In addition, modules or units in the communication apparatus 800 are separately configured to perform actions or processing processes performed by the core network device described in the foregoing method embodiments. As shown in FIG. 8, the communication apparatus 800 may include a processing unit 810 and a communication unit 820. Optionally, the communication apparatus 800 may further include a storage unit 830.

It should be understood that, for a specific process of performing the foregoing corresponding steps by the units in the communication apparatus 800, refer to the related descriptions of the steps performed by the core network device, the monitoring network element, the selection network element, or the deployment network element in the foregoing embodiments with reference to FIG. 3 to FIG. 7A and FIG. 7B. For brevity, details are not described herein again.

Optionally, the communication unit 820 may include a receiving unit (module) and a sending unit (module), configured to perform steps of receiving information and sending information by the PSA, the I-UPF, the access network device, the new I-SMF, or the SMF in the foregoing method embodiments. The storage unit 830 is configured to store instructions executed by the processing unit 810 and the communication unit 820. The processing unit 810, the communication unit 820, and the storage unit 830 are in communication connection. The storage unit 830 stores the instructions. The processing unit 810 is configured to execute the instructions stored in the storage unit. The communication unit 820 is configured to receive or send a specific signal when driven by the processing unit 810.

It should be understood that the communication unit 820 may be a transceiver, an input/output interface, an interface circuit, or the like, the storage unit may be a memory, and the processing unit 810 may be implemented by a processor.

FIG. 9 is a block diagram of a structure of another example of a communication apparatus according to this disclosure. As shown in FIG. 9, the communication apparatus 900 may include a processor 910, a memory 920, a transceiver 930, and a bus system 940. The components of the communication apparatus 900 are coupled together through the bus system 940. The bus system 940 may further include a power bus, a control bus, a status signal bus, and the like in addition to a data bus. However, for clear description, various buses are all marked as the bus system 940 in FIG. 9. For ease of indication, FIG. 9 shows only an example.

It should be further understood that the communication apparatus 900 in FIG. 9 may be a core network device, a monitoring network element, a selection network element, or a deployment network element, or the core network device, the monitoring network element, the selection network element, or the deployment network element may include the communication apparatus 900 in FIG. 9.

The communication apparatus 800 in FIG. 8 or the communication apparatus 900 in FIG. 9 can implement the steps performed by the core network device, the monitoring network element, the selection network element, or the deployment network element in the embodiments shown in FIG. 3 to FIG. 7A and FIG. 7B. For similar descriptions, refer to the descriptions in the foregoing corresponding methods. To avoid repetition, details are not described herein again.

An embodiment of this disclosure further provides a chip system. As shown in FIG. 10, the chip system includes at least one processor 1010 and at least one interface circuit 1020. The processor 1010 and the interface circuit 1020 may be connected to each other through a line. For example, the interface circuit 1020 may be configured to receive a signal from another apparatus. For another example, the interface circuit 1020 may be configured to send a signal to another apparatus. For example, the interface circuit 1020 may read instructions stored in a memory, and send the instructions to the processor 1010. When the instructions are executed by the processor 1010, the chip system may be enabled to perform the steps performed by the core network device, the monitoring network element, the selection network element, or the deployment network element in the foregoing embodiments. Certainly, the chip system may further include another discrete component.

It should be further understood that division into the units in the apparatus is merely logical function division, and in some embodiments, all or some of the units may be integrated into one physical entity, or may be physically separated. In addition, all the units in the apparatus may be implemented in a form of software invoked by a processing element, or may be implemented in a form of hardware; or some units may be implemented in a form of software invoked by a processing element, and some units may be implemented in a form of hardware. For example, each unit may be a separately disposed processing element, or may be integrated into a chip of the apparatus for implementation. In addition, each unit may alternatively be stored in a memory in a form of program to be invoked by a processing element of the apparatus to perform a function of the unit. The processing element herein may also be referred to as a processor, and may be an integrated circuit having a signal processing capability. In an implementation process, each step in the foregoing methods or each unit may be implemented by an integrated logic circuit of hardware in the processor element, or may be implemented in a form of software invoked by the processing element. In an example, a unit in any one of the foregoing apparatuses may be one or more integrated circuits configured to implement the foregoing methods, for example, one or more application-specific integrated circuits (ASIC), one or more digital signal processors (DSP), one or more field programmable gate arrays (FPGA), or a combination of at least two of these forms of integrated circuits. For still another example, when the unit in the apparatus is implemented in a form of scheduling a program by the processing element, the processing element may be a general-purpose processor, for example, a central processing unit (CPU) or another processor that may invoke the program. For still another example, the units may be integrated and implemented in a form of a system-on-a-chip (SOC).

An embodiment of this disclosure further provides an apparatus. The apparatus is included in a core device. The apparatus has a function of implementing the core network device, the monitoring network element, the selection network element, or the deployment network element in any method in the foregoing embodiments. The function may be implemented by hardware, or may be implemented by hardware executing corresponding software. The hardware or the software includes at least one module or unit corresponding to the foregoing function, for example, a detection module or unit, a display module or unit, a determining module or unit, and a computing module or unit.

An embodiment of this disclosure further provides a communication control system based on user intent prediction. The system includes the core network device, the monitoring network element, the selection network element, the deployment network element, and the like that are provided in the foregoing method embodiments.

An embodiment of this disclosure further provides a computer-readable storage medium, configured to store computer program code. The computer program includes instructions used to perform any communication control method based on user intent prediction provided in the foregoing embodiments of this disclosure. The readable medium may be a read-only memory (ROM) or a random access memory (RAM).

This disclosure further provides a computer program product. The computer program product includes instructions. When the instructions are executed, a core network device, a monitoring network element, a selection network element, and a deployment network element perform corresponding operations in the foregoing methods.

An embodiment of this disclosure further provides a chip located in a communication apparatus. The chip includes a processing unit and a communication unit. The processing unit may be, for example, a processor, and the communication unit may be, for example, an input/output interface, a pin, or a circuit. The processing unit may execute computer instructions, so that the communication apparatus performs any communication control method based on user intent prediction provided in the foregoing embodiments of this disclosure.

Optionally, the computer instructions are stored in a storage unit.

Optionally, the storage unit is a storage unit in the chip, for example, a register or a cache. Alternatively, the storage unit may be a storage unit that is in the terminal and that is located outside the chip, for example, an ROM, another type of static storage device that can store static information and instructions, or a random RAM. The processor mentioned above may be a CPU, a microprocessor, an ASIC, or one or more integrated circuits configured to control program execution of the data packet transmission method in the PDU session. The processing unit and the storage unit may be decoupled, are disposed on different physical devices respectively, and are connected in a wired or wireless manner to implement respective functions of the processing unit and the storage unit, to support the system chip in implementing various functions in the foregoing embodiments. Alternatively, the processing unit and the memory may be coupled to a same device.

The communication control method based on user intent prediction, the core network device, the monitoring network element, the selection network element, the deployment network element, the computer-readable storage medium, the computer program product, or the chip provided in embodiments is configured to perform the corresponding method provided above. Therefore, for beneficial effect that can be achieved by the communication control method, the core network device, the monitoring network element, the selection network element, the deployment network element, the computer-readable storage medium, the computer program product, or the chip, refer to the beneficial effect in the corresponding method provided above. Details are not described herein again.

It may be understood that the memory in this embodiment of this disclosure may be a volatile memory or a non-volatile memory, or may include a volatile memory and a non-volatile memory. The non-volatile memory may be an ROM, a programmable read-only memory (PROM), an erasable programmable read-only memory (EPROM), an electrically erasable programmable read- only memory (EEPROM), or a flash memory. The volatile memory may be an RAM, and serves as an external cache. There are a plurality of different types of RAMs such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

In this disclosure, names may be assigned to various objects such as messages/information/devices/network elements/systems/apparatuses/actions/operations/procedures/concepts. It may be understood that the specific names do not constitute a limitation on the related objects. The assigned names may vary with factors such as scenarios, contexts, or usage habits. Understanding of technical meanings of technical terms in this disclosure should be determined mainly based on functions and technical effect embodied/performed by the technical terms in the technical solutions.

In embodiments of this disclosure, unless otherwise stated or there is a logic conflict, terms and/or descriptions between different embodiments are consistent and may be mutually referenced, and technical features in different embodiments may be combined based on an internal logical relationship thereof, to form a new embodiment.

A person of ordinary skill in the art may be aware that units and algorithm steps in the examples described with reference to embodiments disclosed in this specification can be implemented by electronic hardware, or a combination of computer software and electronic hardware. Whether the functions are performed by hardware or software depends on particular disclosures and design constraints of the technical solutions. A person skilled in the art may use different methods to implement the described functions for each particular disclosure, but it should not be considered that the implementation goes beyond the scope of this disclosure.

All or some of the methods in embodiments of this disclosure may be implemented by software, hardware, firmware, or any combination thereof. When software is used to implement the methods, all or some of the methods may be implemented in a form of a computer program product. The computer program product includes one or more computer programs or instructions. When the computer programs or the instructions are loaded and executed on a computer, the procedures or the functions described in embodiments of this disclosure are all or partially executed. The computer may be a general-purpose computer, a dedicated computer, a computer network, or another programmable apparatus. The computer programs or the instructions may be stored in a computer-readable storage medium, or may be transmitted through the computer-readable storage medium. The computer-readable storage medium may be any usable medium accessible by the computer, or a data storage device, for example, a server integrating one or more usable media.

It may be clearly understood by a person skilled in the art that, for convenient and brief description, for a detailed working process of the foregoing system, apparatus, and unit, refer to a corresponding process in the foregoing method embodiments. Details are not described herein again.

In the several embodiments provided in this disclosure, it should be understood that the disclosed system, apparatus, and method may be implemented in other manners. For example, the described apparatus embodiment is merely an example. For example, division into the units is merely logical function division and may be other division in some embodiments. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate components may or may not be physically separate, and components displayed as units may or may not be physical units, may be located in one position, or may be distributed on a plurality of network units. Some or all of the units may be selected based on actual requirements to achieve the objectives of the solutions of embodiments.

In addition, functional units in embodiments of this disclosure may be integrated into one processing unit, each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions of this disclosure essentially, or the part contributing to the conventional technology, or some of the technical solutions may be implemented in a form of a software product. The computer software product is stored in a readable storage medium, and includes several instructions for indicating a computer device (which may be a personal computer, a server, or a network device) to perform all or some of the steps of the methods described in embodiments of this disclosure. The foregoing readable storage medium includes any medium that can store program code, for example, a USB flash drive, a removable hard disk, an ROM, an RAM, a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method comprising:
determining user intent data based on semantic data corresponding to at least one of content or a service that is historically requested by a user, wherein the user intent data reflects a historical intent of the user;
fusing the user intent data and historical data of the at least one of the content or the service that is historically requested by the user;
processing the fused data by using a deep learning network model, to obtain intent prediction information of the user, wherein the intent prediction information comprises a probability that the user sends a request for at least one of the content or the service at a future time; and
performing advance deployment of a network architecture and advance configuration of a network resource based on the intent prediction information.

2. The method according to claim 1, wherein the determining user intent data based on semantic data corresponding to the at least one of content or the service that is historically requested by the user comprises:
separately performing, by using a natural language processing model, semantic encoding on keywords comprised in the semantic data, to obtain a plurality of semantic feature vectors, wherein the semantic feature vector indicates a semantic similarity and an analogy of the keywords; and
performing semantic aggregation on the plurality of semantic feature vectors, to obtain the user intent data.

3. The method according to claim 2, wherein semantic aggregation is performed on the plurality of semantic feature vectors in at least one of the following manners, to obtain the user intent data:
addition, averaging, a deep learning model based on a recurrent neural network, or a deep learning model based on an attention mechanism.

4. The method according to claim 1, wherein the fusing the user intent data and historical data of the at least one of the content or the service that is historically requested by the user comprises:
fusing, in a manner of addition or concatenation, the user intent data and the historical data of the content or the service that is historically requested by the user.

5. The method according to claim 1, wherein the fusing the user intent data and historical data of the content or the service that is historically requested by the user comprises:
preprocessing the historical data of the at least one of the content or the service that is historically requested by the user; and
fusing, in a manner of addition or concatenation, the user intent data and preprocessed historical data of the at least one of the content or the service that is historically requested by the user, wherein
the preprocessing comprises at least one of averaging the historical data of the at least one of the content or the service that is historically requested by the user, using the deep learning model based on at least one of a recurrent neural network or an attention mechanism, or selecting, based on a time parameter, the historical data of the at least one of the content or the service that is historically requested by the user.

6. The method according to claim 1, wherein the processing the fused data by using a deep learning network model, to obtain intent prediction information of the user comprises:
obtaining, by using the deep learning network model, information of nodes in the historical data of the at least one of the content or the service that is historically requested by the user, wherein the nodes comprise the user and the at least one of the content or the service that is requested by the user;
generating, for each node by using the deep learning network model, a vector representation comprising a structure feature, a time feature, and a semantic feature, wherein the time feature is a time at which the user requests the at least one of the content or the service;
calculating a matching value between the user and the at least one of the content or the service by using the deep learning network model; and
obtaining the intent prediction information based on the matching value.

7. The method according to claim 6, wherein the historical data of the content or the service that is historically requested by the user comprises:
a user ID of the user that initiates a request in a preset time length,
at least one of an identifier (ID) of the content or the service that is requested in the preset time length,
time information of the request initiated by the user in the preset time length.

8. The method according to claim 1, wherein the performing advance deployment of a network architecture and advance configuration of a network resource based on the intent prediction information comprises:
based on the intent prediction information and by using a monitoring network element, determining whether the intent prediction information meets a preset threshold, determining whether a current policy meets a requirement, and recording the historical data of the at least one of the content or the service that is historically requested by the user and the semantic data corresponding to the at least one of the content or the service that is historically requested by the user;
updating and optimizing the current policy by using a selection network element;
converting, by using a deployment network element, the current policy or an updated policy into a control instruction for a wireless network infrastructure according to a configuration instruction specification of a network parameter; and
executing the control instruction by using an execution network element, to perform the advance deployment of the network architecture and advance configuration of a communication and computing resource for the at least one of the content or the service that is requested by the user.

9. The method according to claim 8, wherein the monitoring network element, the selection network element, the deployment network element, and the execution network element are core network elements.

10. A communication apparatus comprising a memory and a processor, wherein the processor is configured to execute instructions stored in the memory to cause the communication apparatus to:
determine user intent data based on semantic data corresponding to at least one of: content or a service that is historically requested by a user, wherein the user intent data reflects a historical intent of the user;
fuse the user intent data and historical data of the at least one of the content or the service that is historically requested by the user;
process the fused data by using a deep learning network model, to obtain intent prediction information of the user, wherein the intent prediction information comprises a probability that the user sends a request for at least one of the content or the service at a future time; and
perform advance deployment of a network architecture and advance configuration of a network resource based on the intent prediction information.

11. The communication apparatus according to claim 10, wherein the processor is further configured to execute the instructions to cause the communication apparatus to:
separately perform, by using a natural language processing model, semantic encoding on keywords comprised in the semantic data, to obtain a plurality of semantic feature vectors, wherein the semantic feature vector indicates a semantic similarity and an analogy of the keywords; and
perform semantic aggregation on the plurality of semantic feature vectors, to obtain the user intent data.

12. The communication apparatus according to claim 11, wherein the processor is further configured to execute the instructions to perform semantic aggregation on the plurality of semantic feature vectors in at least one of the following manners, to obtain the user intent data:
addition, averaging, a deep learning model based on a recurrent neural network, or a deep learning model based on an attention mechanism.

13. The communication apparatus according to claim 10, wherein the processor is further configured to execute the instructions to cause the communication apparatus to:
fuse, in a manner of addition or concatenation, the user intent data and the historical data of the content or the service that is historically requested by the user.

14. The communication apparatus according to claim 10, wherein the processor is further configured to execute the instructions to cause the communication apparatus to:
preprocess the historical data of the at least one of the content or the service that is historically requested by the user; and
fuse, in a manner of addition or concatenation, the user intent data and preprocessed historical data of the at least one of the content or the service that is historically requested by the user, wherein the preprocessing comprises at least one of averaging the historical data of the at least one of the content or the service that is historically requested by the user, using the deep learning model based on at least one of a recurrent neural network or an attention mechanism, or selecting, based on a time parameter, the historical data of the at least one of the content or the service that is historically requested by the user.

15. The communication apparatus according to claim 10, wherein the processor is further configured to execute the instructions to cause the communication apparatus to:
obtain, by using the deep learning network model, information of nodes in the historical data of the at least one of the content or the service that is historically requested by the user, wherein the nodes comprise the user and the at least one of the content or the service that is requested by the user;
generate, for each node by using the deep learning network model, a vector representation comprising a structure feature, a time feature, and a semantic feature, wherein the time feature is a time at which the user requests the at least one of the content or the service;
calculate a matching value between the user and the at least one of the content or the service by using the deep learning network model; and
obtain the intent prediction information based on the matching value.

16. The communication apparatus according to claim 15, wherein the historical data of the content or the service that is historically requested by the user comprises:
a user ID of the user that initiates a request in a preset time length,
at least one of an identifier (ID) of the content or the service that is requested in the preset time length,
time information of the request initiated by the user in the preset time length.

17. The communication apparatus according to claim 10, wherein the processor is further configured to execute the instructions to cause the communication apparatus to:
based on the intent prediction information and by using a monitoring network element, determine whether the intent prediction information meets a preset threshold, determining whether a current policy meets a requirement, and recording the historical data of the at least one of the content or the service that is historically requested by the user and the semantic data corresponding to the at least one of the content or the service that is historically requested by the user;
update and optimizing the current policy by using a selection network element;
convert, by using a deployment network element, the current policy or an updated policy into a control instruction for a wireless network infrastructure according to a configuration instruction specification of a network parameter; and
execute the control instruction by using an execution network element, to perform the advance deployment of the network architecture and advance configuration of a communication and computing resource for the at least one of the content or the service that is requested by the user.

18. A non-transitory computer-readable storage medium, wherein the computer-readable storage medium stores a computer program, the computer program comprises program instructions, and when the program instructions are executed by a processor, the processor is caused to:
determine user intent data based on semantic data corresponding to at least one of: content or a service that is historically requested by a user, wherein the user intent data reflects a historical intent of the user;
fuse the user intent data and historical data of the at least one of the content or the service that is historically requested by the user;
process the fused data by using a deep learning network model, to obtain intent prediction information of the user, wherein the intent prediction information comprises a probability that the user sends a request for at least one of the content or the service at a future time; and
perform advance deployment of a network architecture and advance configuration of a network resource based on the intent prediction information.

19. The non-transitory computer-readable storage medium according to claim 18, wherein when the program instructions are executed by the processor, the processor is further configured to:
separately perform, by using a natural language processing model, semantic encoding on keywords comprised in the semantic data, to obtain a plurality of semantic feature vectors, wherein the semantic feature vector indicates a semantic similarity and an analogy of the keywords; and
perform semantic aggregation on the plurality of semantic feature vectors, to obtain the user intent data.

20. The non-transitory computer-readable storage medium according to claim 18, wherein when the program instructions are executed by the processor, the processor is further configured to perform semantic aggregation on the plurality of semantic feature vectors in at least one of the following manners, to obtain the user intent data:
addition, averaging, a deep learning model based on a recurrent neural network, or a deep learning model based on an attention mechanism.
